(19) United States
(12) Patent Application Publication
(10) Pub. No.: US 2026/0267726 A1
(43) Pub. Date: Sep. 10, 2026

(54) METHOD FOR FORWARDING DATA FROM A PLURALITY OF DATA SOURCES TO A DATA SINK

(71) Applicant: Robert Bosch GmbH, Stuttgart (DE)

(72) Inventors: Peter Schneider, Holzgerlingen (DE); Dennis Grewe, Renningen (DE); Pooja Dahane, Ludwigshafen (DE)

(21) Appl. No.: 19/148,805

(22) PCT Filed: Jan. 18, 2024
(86) PCT No.: PCT/EP2024/051125

§ 371 Date: Jul. 17, 2025

(30) Foreign Application Priority Data
Mar. 13, 2023 (DE) 10 2023 202 226.5

(51) Int. Cl. G06F 11/07

(52) U.S. Cl. CPC G06F 11/0772; G06F 11/0709; G06F 11/079

(57) ABSTRACT

A method for forwarding data from a plurality of data sources to a data sink. The method includes forwarding data, which were received from a first data source and forwarded from a comparison device, to the data sink by a monitoring device before the monitoring device has received control information, which indicates a result of a comparison of the data received from the first data source with data received from one or more second of the data sources, from the comparison device; and signaling a fault state to the data sink if the monitoring device has not received the control information, which indicates a result of the comparison, from the comparison device within a fault detection time after forwarding the received data to the data sink, or if the control information indicates a negative result.

### FIELD

The present invention relates to methods for forwarding data from a plurality of data sources to a data sink.

### BACKGROUND INFORMATION

Technical systems, for example from the automotive sector, place very high demands on the reliability of their functionality (i.e., systems with simultaneously high requirements for the accuracy of the provided data, outputs, or signals and/or for their timely availability). An example of systems with particularly demanding reliability requirements are steer-by-wire control systems. Typically, N redundant data sources (such as functions or data channels) are used in such systems in particular to safeguard the provision and/or processing of data with respect to erroneous results or failures.

Depending on the number of redundant data sources, faults can only be detected (in this case, N>=2) or faults/failures can even be compensated at times (in this case, N>=3). In both cases, a so-called comparator (voter) is typically used, which compares the results of the N data sources with one another and then decides which data (e.g., outputs or signals) are considered correct and are forwarded to a data sink.

However, depending on the system in which such an approach is used, delays can occur if the comparator waits to receive data from all data sources (e.g., via all N channels) so that it can perform the comparison, but the data provision of one of the data sources is delayed (e.g., because one channel is currently too slow).

Approaches that make it possible to forward the data to a data sink with little delay even in the case of high requirements for the reliability of data are therefore desirable.

### SUMMARY

According to various embodiments of the present invention, a method for forwarding (payload) data from a plurality of data sources to a data sink is provided, comprising forwarding data, which were received from a first data source and forwarded from a comparison device, by a monitoring device to the data sink before the monitoring device has received control information, which indicates a result of a comparison of the data received from the first data source with data received from one or more second of the data sources, from the comparison device; and signaling a fault state to the data sink (e.g., by the monitoring device) if the monitoring device has not received the control information, which indicates a result of the comparison, from the comparison device within a (specified) fault detection time after forwarding the received data to the data sink, or if the control information indicates a negative result.

To put it simply, data stream and fault detection are decoupled in the method of the present invention described above and in the embodiments of the present invention described below. This can achieve nearly latent-free protection of a data stream, e.g., by means of an M-out-of-N comparison scheme, without significantly restricting the integrity monitoring. While the end-to-end latency of a (data processing) cycle is determined by the slowest channel if forwarding occurs only after the comparison result is available, the method described above can achieve that the end-to-end latency of a data processing cycle is determined by the fastest channel.

There is also the possibility of reusability and integration: Separating comparator (comparison device) and decider (monitoring device) makes it possible to reuse a common FIFO comparator for multiple applications, all applications receiving the same control information and each application integrating its own instance of a decider with application-specific monitoring parameters and fault responses.

Separating comparator and decider as well as data stream and fault detection furthermore makes good scalability possible, e.g., by the cascaded use of multiple successive FIFO comparators in larger distributed systems with a multitude of data sources and processing paths (which then together form a comparison device, for example), wherein control information is aggregated. The analysis of the aggregated control information (from the successive FIFO comparators) can be carried out centrally in the monitoring device provided for the data sink (e.g., at the data sink).

Various exemplary embodiments of the present invention are specified below.

Exemplary embodiment 1 is a method for forwarding data from a plurality of data sources to a data sink, as described above.

Exemplary embodiment 2 is a method according to exemplary embodiment 1, comprising receiving the data from the first of the data sources by the comparison device; forwarding the data received from the first data source, to the monitoring device by the comparison device before the comparison device has completed the comparison; performing the comparison by the comparison device; and transmitting the control information, which indicates a result of the comparison, from the comparison device to the monitoring device.

By forwarding to the monitoring device by the comparison device before the comparison is completed, the delay can be kept small.

Exemplary embodiment 3 is a method according to exemplary embodiment 1 or 2, comprising signaling a first fault state to the data sink by the monitoring device if the monitoring device has not received the control information, which indicates a result of the comparison, from the comparison device within a fault detection time after forwarding the received data to the data sink; and signaling a second fault state to the data sink by the monitoring device if the control information indicates a negative result.

The data sink can then respond differently depending on whether the forwarded data were erroneous (which is indicated by the negative comparison result, i.e., mismatch of the data received from the data sources), or the data could not yet be verified (i.e., the fault detection time has expired).

Exemplary embodiment 4 is a method according to one of exemplary embodiments 1 to 3, wherein the comparison is an M-out-of-N comparison.

Accordingly, the result of the comparison is negative if the data (for the same processing cycle) from fewer than M data sources match. Through the selection of M and N, a desired safety can be achieved.

Exemplary embodiment 5 is a method according to one of exemplary embodiments 1 to 3, comprising performing the forwarding for data received from the data sources for each of multiple processing cycles and further comprising triggering a reconfiguration for a data source for the one number of processing cycles for which the particular comparison indicated that the data from the data source are erroneous, or for which the data from the data source have been received by the comparison device with a delay above a delay threshold value.

For example, a reconfiguration (e.g., a relocation of software implementing the data source to different hardware, or another orchestration measure) can be performed if the data from the data source were repeatedly erroneous or if the data were repeatedly received from the data source so late that they could not be used for a comparison so that the comparison result could or could have been forwarded to the monitoring device within the fault detection time.

To this end, it may be provided that, if a fault state is signaled, information about the faulty data source(s) (which are faulty because they produce late results or results that deviate from the majority) is also transmitted.

Exemplary embodiment 6 is a data processing arrangement configured to perform a method according to one of exemplary embodiments 1 to 5.

Depending on the particular case, the communication system may only include the monitoring device or also the monitoring device, the comparison device, and/or the data sinks, i.e., the data processing arrangement may be a communication system or only parts thereof.

Exemplary embodiment 7 is a computer program comprising commands that, when executed by one or more processors, cause the one or more processors to perform a method according to one of exemplary embodiments 1 to 5.

Exemplary embodiment 8 is a computer-readable medium which stores commands that, when executed by one or more processors, cause the one or more processors to perform a method according to one of exemplary embodiments 1 to 5.

Various examples are described in more detail below.

In the figures, like reference signs generally refer to the same parts throughout the various views. The figures are not necessarily to scale, emphasis being instead generally placed on representing the principles of the present invention. Various aspects are described in the following description with reference to the figures.

### BRIEF DESCRIPTION OF THE DRAWINGS

FIG. 1 shows a communication system.

FIG. 2 shows a communication system according to one example embodiment of the present invention.

FIG. 3 shows a flowchart illustrating a method for forwarding data from a plurality of data sources to a data sink, according to one example embodiment of the present invention.

### DETAILED DESCRIPTION OF EXAMPLE EMBODIMENTS

The following detailed description relates to the figures, which, for clarification, show specific details and aspects of this disclosure in which the present invention can be implemented. Other aspects can be used, and structural, logical, and electrical changes can be carried out without departing from the scope of protection of the present invention. The various aspects of this disclosure are not necessarily mutually exclusive since some aspects of this disclosure may be combined with one or more other aspects of this disclosure in order to form new aspects.

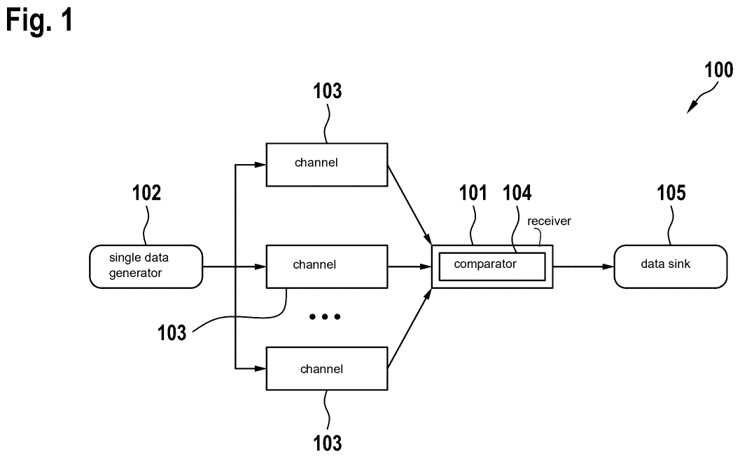

In informatics, the process of decision-making is a known problem in distributed, fault-tolerant computing systems or systems that want to achieve agreement on a single data value. Algorithms for solving this problem are known as consensus algorithms. Application areas of such algorithms are typically large distributed applications that are operated in data centers. Examples of conventional algorithms are the Paxos algorithm and the Raft algorithm. Both are based on a decision being made by majority decision. If this is not possible, a so-called master node makes the final decision. Such methods, however, required a certain bi-directional communication effort between the nodes involved, which results in additional latency in comparison to the processing chain. Due to this property, the use of such algorithms in the context of real-time systems with hard latency requirements is uncommon. Instead, M-out-of-N schemes are used in such cases, as described below with reference to FIG. 1.

FIG. 1 shows a communication system (or processing system, hereinafter also simply referred to as a system) 100.

A receiver 101 receives data from multiple data sources, wherein the data sources are formed by a single data generator 102 (e.g., a sensor), which transmits data via multiple channels 103 (i.e., each of the multiple data sources corresponds to a combination of data generator 102 and respective channel). However, the data sources may also be separate data generators (e.g., separate sensors), each of which is connected to the receiver 101 via a channel 103. The data generator 102 may also itself be an input (e.g., a receiver).

The receiver 101 contains a comparator 104, which compares data received from the data sources (i.e., via the channels in this example) and, in the case of a sufficient match, forwards them to a data sink 105 (e.g., a control device, e.g., a control unit (ECU) in a vehicle that controls an actuator, e.g., a brake, for an ABS (anti-lock brake system) or an ESP (electronic stability program)). A sufficient match means, for example, an M-out-of-N match, i.e., a match of (at least) M data packets among N received data packets, wherein the data packets correspond to one another, i.e., belong to the same (data) processing cycle, for example have the same sequence number from a data stream (e.g., for the same data processing cycle, e.g., control cycle, of a sequence of data processing cycles).

The communication system 100 thus implements a so-called M-out-of-N comparison scheme, for example. The comparison of the data (e.g., outputs of a sensor or other signals) of the N channels is typically carried out in (communication) systems with high requirements for safety integrity for each cycle in which new data are provided. For example, for a control interval of, for example, 50 ms, a comparison of the incoming data and a direct decision as to whether the system is functioning correctly or whether there is a fault and the data may have to be discarded are carried out in the same interval.

For (safety-relevant) real-time systems, such M-out-of-N comparison schemes are typically only used with spatially close and generally locally networked and closely synchronized (generally embedded) system components. Such systems of locally networked components are typically well time-synchronized with one another, for example via a global time (in the local system) to which all system components regularly synchronize. It is thus possible to keep the execution of the data processing steps between the N channels 103 and the subsequent comparator 104 time-synchronous. The tight time synchronization makes it possible for the comparison in each data processing cycle to be processed by the comparator almost without delay. The data provision to the data sink 105 in such a local networked system is therefore carried out with a very small additional latency in comparison to the processing chain in a single-channel system without redundancies and comparators.

In widely distributed systems, the components of which are networked, for example, via the Internet or other public and shared networks (e.g., cellular networks) (i.e., in which the channels 103 are provided by such networks), it is much more difficult to implement an M-out-N comparison scheme for safeguarding reliability requirements (with respect to integrity and timely availability of data), since the following differences over a system with faster (e.g., locally) networked components exist:
1) A precise common time base between the components generally does not exist; because of (2), it is difficult to establish a precise common time base and keep it synchronous.
2) The transmission times of individual messages/data packets vary greatly in packet-based, dynamically routed network communications. For example, with high network utilization, packets may arrive much later than would be the case with low network utilization or on average (or may not arrive at all).
3) In the event of defects or temporary disruptions of the transmission path, communication failures or delays may occur between individual components of the system. Wireless connections (e.g., for V2X communication channels) are generally more susceptible to interference than wired connections.

If an M-out-of-N scheme as described with reference to FIG. 1 is used in such a widely distributed, networked system, wherein a high level of integrity of the data (i.e., erroneous contents are sufficiently quickly identified as erroneous) and timeliness of the data (e.g., current data in cycles of 20 ms each) are simultaneously required, difficulties arise as summarized in Table 1 by way of example for a 2-out-of-3 scheme and explained below. For each processing cycle, it is specified which data each channel currently supplies (which may still be data for the previous processing cycle since they and the current data are delayed).

TABLE 1

| Cycle | z0 | z1 | z2 | z3 | z4 |
|---|---|---|---|---|---|
| Channel 1 | [z0 \| uvwx] | [z1 \| abcd] | [z2 \| efgh] | [z3 \| bfgh] | [z4 \| yzab] |
| data: | | | (erroneous) | (erroneous) | |
| Channel 2 | [z0 \| uvwx] | [z1 \| abcd] | — | [z2 \| afgh] | [z4 \| ulmn] |
| data: | | | | | (erroneous) |
| Channel 3 | [z0 \| uvwx] | — | [z1 \| abcd] | [z2 \| afgh] | [z4 \| efgh] |
| data: | | | | | (erroneous) |
| FIFO result | [z0 \| uvwx] | [z1 \| abcd] | [z2 \| efgh] | [z3 \| bfgh] | [z4 \| ????] |
| | | | (unidentified | (unidentified | (unidentified |
| | | | error) | error) | error |
| (result | | | | | in 2 out |
| without | | | | | of 3 |
| comparison) | | | | | cases) |
| 2-out-of-3 | [z0 \| uvwx] | [z1 \| abcd] | fault | fault | fault |
| comparison | | | indicated | indicated | indicated |
| result | | | (too | (too | (inconsistency |
| | | | little z2 | little z3 | discovered) |
| | | | data) | data) | |
| 3-out-of-3 | [z0 \| uvwx] | fault | fault | fault | fault |
| comparison | | indicated | indicated | indicated | indicated |
| result | | (too | (too | (too | (inconsistency |
| | | little z1 | little z2 | little z3 | discovered) |
| | | data) | data) | data) | |

Case 1 (waiting for data for comparison): If the comparator 104 in a cycle z1 waits for the input of all data/signals/outputs of the N channels in order to safeguard the cycle with respect to integrity, there is a non-negligible probability in widely distributed systems that a delayed provision of the results occurs in at least one of the N channels due to one of the three aforementioned properties and that the real-time requirements are violated (i.e., z1 exceeds its maximum allowed time window). This is shown by way of example in Table 1 in column z1 for the 3-out-of-3 comparison.

Case 2 (direct forwarding): If a time-optimized first-in-first-out behavior is selected (i.e., the comparator 104 only compares the data available at the current time and forwards data unchecked if they cannot be falsified in time), there is a risk of erroneous data being received at the data sink, which data can no longer be identified as erroneous there. Such a case is shown, for example, in Table 1 in column z2 and z3.

In both cases, at least one of the requirements (high integrity and timeliness, i.e., low latency) is violated. In addition, an additional (variable) processing latency in the form of the wait time in the comparator is added to the processing chain. In the more favorable case 1, a controlled fault response occurs, e.g., by switching off or interrupting a functionality in the data sink 105. In the more unfavorable case 2, an unnoticed forwarding of errors to the data sink 105 occurs. Since case 1 is often expected in widely distributed, networked systems, this concept is not well-suited for many applications in practice. One reason for this is potential network problems that may directly impact the system behavior and may result in frequent functional degradations in the data sink 105.

According to various embodiments, an approach that makes it possible to implement real-time-critical and safety-critical applications even in geographically widely distributed and (in the most difficult case, wirelessly) networked systems is provided. To this end, as described below, an approach that makes it possible to use an M-out-of-N comparison scheme in distributed systems without restricting the achievable requirements with respect to integrity and/or the reception of the data/signals at the right time (i.e., low latency) too much is provided. To this end, the functionality of the comparator 104 is distributed according to various embodiments.

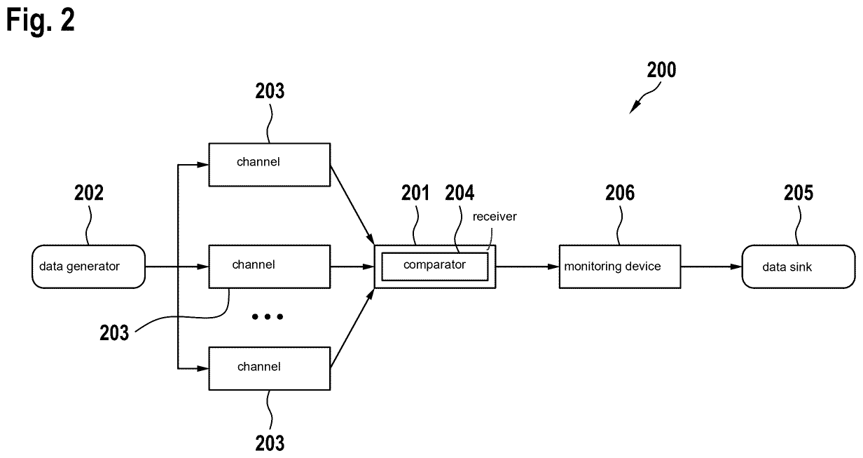

FIG. 2 shows a communication system 200 according to one embodiment.

Analogously to the communication system 100 of FIG. 1, the communication system 200 comprises a receiver 201, a data generator 202, multiple channels 203, and a data sink 205. As explained above with reference to FIG. 1, a separate data generator for each data source may also be provided.

The communication system 200 differs from the communication system 100 of FIG. 1 in that, instead of the comparator 104, a FIFO (first-in-first-out) comparator 204 (in receiver 201) is provided, followed by a monitoring device 206 (or decision-making device, hereinafter also referred to as a (metadata) watchdog). The monitoring device 206 is typically geographically close to the data sink 205; e.g., it may be provided together with the data sink 205 in one component (e.g., in one device). The receiver 201, on the other hand, may be in a separate component.

The FIFO comparator 204 and the monitoring device 206 implement a two-part M-out-of-N comparison scheme extended by cycle-specific meta-information. This takes advantage of the fact that safety-relevant real-time applications generally have a so-called fault tolerance time interval (FTTI), during which a fault propagated in the system between the components cannot yet cause hazardous effects. By way of example, a braking process from the automotive sector is to be considered. A fault-related braking intervention for a few milliseconds results only in a brief jolt in the vehicle, which constitutes an impairment of driving comfort but not of safety. A portion of this application-specific fault tolerance time interval is utilized in the extended comparison scheme for time-delayed fault detection (as the fault detection time (interval) FDTI), during which (payload) data can be forwarded almost without delay to the subsequent system components.

The FIFO comparator 204 and the monitoring device 206 have the following functionalities for this purpose:
The FIFO comparator (also referred to as the comparison device) 204 performs a retrospective M-out-of-N comparison on the basis of (e.g., temporarily stored) meta-information about the received data and then sends the comparison result in the form of (meta) control information to the monitoring device 206 (e.g., via a separately transmitted safety metadata signal).
On the basis of the control information generated by the FIFO comparator, the monitoring device 206 monitors the data forwarding by analyzing the control information and by triggering a fault response in the data sink 205 (e.g., switching off selected functions) in the event of a fault or in the absence of the positive control information. Additionally, the monitoring device 206 according to one embodiment implements (likewise on the basis of the control information) extended fault diagnosis measures in order, for example, to identify a persistently unreliable channel 203 and to restore the desired reliability of the overall system automatically, if necessary by reconfiguring the unreliable channel at run time.

In the following, the functionalities of the FIFO comparator 204 and of the monitoring device (watchdog) 206 according to one exemplary embodiment are described in more detail.

The FIFO comparator 204 processes all data associated with a new cycle in two phases.

In phase 1, the FIFO comparator 204 receives (payload) data (or signals/outputs) for a current comparison cycle. Due to the aforementioned slight asynchronism, the data of one of the N redundant channels 203 arrive first in the FIFO comparator 204 and are initially forwarded unchecked from said FIFO comparator to the watchdog 206 (with little delay). When forwarding the data, the FIFO comparator also in particular adds the following meta-information:
Number/ID of the channel or application/function via which the data were received
Sequence number/ID identifying the data as being associated with a cycle

In parallel therewith, the FIFO comparator 204 stores the mentioned meta-information about the forwarded data internally and, in phase 2, performs a retrospective comparison between the data of a cycle whenever the data (associated with the same cycle) from at least one further of the remaining N−1 channels have been received. Up to N−1 comparisons between the same data of a cycle (in the fault-free case) are performed, and (meta) control information is updated each time with the results of the last comparison. The transmission of control information to the decider is carried out in one embodiment whenever a further comparison of the payload data of a cycle has been carried out (namely whenever data for the considered processing cycle have been received from a further data source). For example, first control information is created and sent to the watchdog when the data of a cycle of at least two out of N channels are present in the FIFO comparator so that a first (2-out-of-N) comparison is possible. The results of this first comparison are then sent to the watchdog 206 so that it can be decided there whether a confirmation from two channels is already sufficient or whether waiting for confirmation by further channels is carried out before the data are considered to be sufficiently verified for use in the data sink (i.e., the watchdog 206 can select M accordingly).

A failure of the (FIFO) comparator 204 and/or of the transmission of the control information can be detected in the watchdog 206 via so-called timeout monitoring. In a variant in which the FIFO comparator 204 is implemented entirely in software, automated repair attempts for an incorrectly functioning FIFO comparator 204 may, for example, be triggered by the watchdog 206, wherein the FIFO comparator software is transferred to another execution platform, for example by means of suitable virtualization technology and configuration commands to an orchestration software, and can resume operation there after successful migration.

In order to avoid that the amount of information to be provided about already forwarded data continues to increase with time in the FIFO comparator 204, outdated data are deleted there in one embodiment after a certain time (e.g., data that have already been forwarded a configurable number of seconds ago). A unique sequence number assigned to each cycle can also be used to filter outdated data (e.g., coming from a channel whose data reach the FIFO comparator much too late) directly out of the data stream so that no unnecessary resources in the FIFO comparator 204 and in the further network communication are occupied by the watchdog 206. This sequence number can either be set by the particular data source itself, for example as part of a header field within the payload data, or via appropriate setting of header fields in the underlying transport protocol.

The (metadata) watchdog 206 also works in two distinguishable phases. In phase 1 (information acquisition), the watchdog 206 receives new payload data, together with first meta information (i.e., channel number/ID, timestamp of the forwarding, sequence number of the data, etc.), from the FIFO comparator 204 and stores them internally with the assistance of a local timestamp. On the basis of the meta-information (e.g., sequence number), it then checks whether these payload data have already been forwarded to the data sink 205. If so, the data are discarded. If the payload data are new (i.e., not yet forwarded) payload data, it forwards them to the data sink 205. Furthermore, it starts a countdown fault detection timer for forwarded payload data of a cycle (i.e., payload data with their own sequence number/ID). The duration corresponds to the maximum desired fault detection time (FDTI) of the particular application.

In phase 2 (verification and retrospective through consideration of the control information generated by the comparator 204, which control information indicates the result of the retrospective comparison), which is initiated by the start of the fault detection timer, the watchdog waits for further meta-information, which is needed for verification or falsification of the already forwarded data, from the FIFO comparator. If such a timer reaches the value of zero before the watchdog 206 has received control information, which indicates that the payload data could be sufficiently verified by receiving further associated data (e.g., data packets having the same sequence number or ID) from another channel, from the comparator 204, the watchdog considers the payload data to be erroneous.

As soon as the watchdog 206 receives new control information, it checks whether the already forwarded data are verified (at least in part) or, if applicable, falsified.

Table 2 illustrates the flow in the FIFO comparator 204 for an example in which it receives data from three sources (S1, S2, S3), i.e., N=3.

Table 3 shows the corresponding generation of (meta) control information by the FIFO comparator 204.

Table 4 illustrates the flow in the monitoring device 206 for the example, specifically what data are forwarded from the monitoring device 206 to the data sink 205.

Table 5 shows the analysis of the control information in the watchdog 206 for the example. The transfer of the control information from the comparator 204 to the monitoring device 206 in this example takes 10 ms.

The example extends over multiple processing cycles. The sequence number (seq. no.) indicates the particular processing cycle of the application to be monitored.

In the example of Tables 2 to 5, a 2-out-of-3 comparison scheme is used. The maximum fault detection time is 100 ms in the example.

TABLE 2

| | Send new | | | |
|---|---|---|---|---|
| | control | Data | Data hash | |
| Seq. no. | information | source | value | Timestamp |
| 05 | no | S1 | #A2B4 | 3421 |
| 05 | yes | S2 | #A2B4 | 3451 |
| 05 | yes | S3 | #A2B4 | 3459 |
| 06 | no | S2 | #03F9 | 3471 |
| 06 | yes | S3 | #03F9 | 3492 |
| 07 | no | S1 | #F711 | 3524 |
| 06 | yes | S1 | #62BA | 3530 |
| | | | (erroneous ) | |
| 07 | yes | S3 | #F711 | 3555 |
| 08 | no | S2 | #C02B | 3570 |
| . . . | . . . | . . . | . . . | . . . |

TABLE 3

| | |
|---|---|
| T = 3451 | [05 \| S1:ok, S2:ok] |
| T = 3459 | [05 \| S1:ok, S2:ok, S3:ok] |
| T = 3492 | [06 \| S2:ok, S3:ok] |
| T = 3530 | [06 \| S1:nok, S2:ok, S3:ok] |
| T = 3555 | [07 \| S1:ok, S2:ok] |

TABLE 4

| Seq. no. | Data source | Timestamp | Timestamp + FDTI |
|---|---|---|---|
| 05 | S1 | 3421 | 3421 + 100 = 3521 |
| 06 | S2 | 3471 | 3471 + 100 = 3571 |
| 07 | S1 | 3524 | 3524 + 100 = 3624 |
| 08 | S2 | 3570 | 3570 + 100 = 3675 |
| . . . | . . . | . . . | . . . |

TABLE 5

| | |
|---|---|
| T = 3462 < 3521 | 05: S1=S2 ok -> wait for S3 |
| T = 3469 < 3521 | 05: S1=S2=S3 ok -> no fault |
| T = 3502 < 3571 | 06: S2=S3 ok -> wait for S1 |
| T = 3540 < 3571 | 06: S1 nok -> fault in S1 |
| T = 3565 < 3624 | 07: S1=S3 ok -> wait for S2 |
| . . . | . . . |

In the event that the control information identifies forwarded data of a processing cycle as erroneous, the watchdog 206 checks in phase 2 of the processing whether the already forwarded data of the relevant processing cycle were based on a channel identified as faulty or on a channel verified as correct as the data source. The following cases may occur:
1) If the retrospective comparison (or the retrospective consideration, i.e., the retrospective check of the associated control information) shows that the forwarded data were correct (i.e., the result of the M-out-of-N comparison in the retrospective comparison by the comparator 204 was positive), no further actions are to be taken by the watchdog 206. It did not forward any erroneous data to the data sink 205 in phase 1.
2) If the retrospective comparison shows that the forwarded data were erroneous, error propagation (limited in time) to the data sink 205 took place and the watchdog 206 signals this to the data sink 205. The data sink then triggers a suitable fault response as needed, e.g., a functional limitation.
3) If the cycle-specific fault detection timer expires before 1) or 2) occurs, the forwarded data are assumed by the watchdog to be potentially erroneous and appropriate signaling is performed by the watchdog 206 and, if necessary, an appropriate fault response is performed in the data sink 205.

The described mechanisms in the watchdog 206 ensure that erroneous data are always identified as such within the fault detection time FDTI and an effect of a fault can be stopped in a timely manner without significantly increasing the latency of the data processing chain in the fault-free case by the M-out-of-N comparison scheme described here.

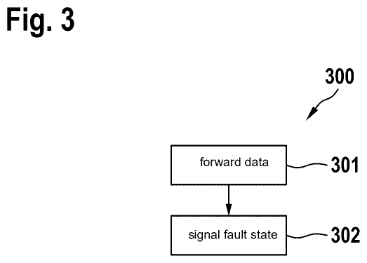

In summary, a method is provided according to various embodiments, as shown in FIG. 3.

FIG. 3 shows a flowchart 300 illustrating a method for forwarding data from a plurality of data sources to a data sink, according to one embodiment.

In 301, data received from a first data source and forwarded from a comparison device are forwarded to the data sink by a monitoring device before the monitoring device has received control information, which indicates a result of a comparison of the data received from the first data source with data received from one or more second of the data sources, from the comparison device.

In 302, a fault state is signaled to the data sink if the monitoring device has not received the control information, which indicates a result of the comparison, from the comparison device within a fault detection time after forwarding the received data to the data sink, or if the control information indicates a negative result.

The method of FIG. 3 can be performed by one or more computers comprising one or more data processing units. The term “data processing unit” may be understood to mean any type of entity that makes the processing of data or signals possible. The data or signals may, for example, be processed according to at least one (i.e., one or more than one) specific function performed by the data processing unit. A data processing unit may comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the particular functions described in more detail here can also be understood as a data processing unit or logic circuit arrangement. One or more of the method steps described in detail here can be carried out (e.g., implemented) by a data processing unit by means of one or more specific functions performed by the data processing unit.

According to various embodiments, the method is thus, in particular, computer-implemented.

The method may be used for various systems having multiple data sources, in particular those that place high demands on reliability and/or latency. Examples include:
Electronic control units (ECUs) in vehicles, for example for powertrain controllers, braking systems, assistance systems, etc.
Fieldbus programmable logic controllers (PLC), also virtualized versions, in the industrial sector
Further control devices, in particular in the aforementioned sectors, such as network gateways

An application example is a vehicle with integrated sensors and sensors connected via a wireless network and mounted on a road (external sensors from a vehicle perspective) as data sources, wherein a comparison device is mounted in the vehicle and monitors the redundant information of the integrated and external sensors according to the method presented.

A further application example is a computer-aided process control of a production plant in which control algorithms for increasing the failure safety and safety integrity are calculated redundantly on multiple different computers and whose resulting control commands are monitored in a special safety controller (so-called safety programmable logic controller) by means of a comparison device according to the method presented.

1-8. (canceled)

9. A method for forwarding data from a plurality of data sources to a data sink, comprising:
forwarding data received from a first data source of the data sources and forwarded from a comparison device to the data sink by a monitoring device before the monitoring device has received control information, the control information indicates a result of a comparison of the data received from the first data source with data received from one or more second data sources of the data sources, from the comparison device; and
signaling a fault state to the data sink: (i) when the monitoring device has not received the control information, which indicates the result of the comparison, from the comparison device within a fault detection time after forwarding the received data to the data sink, or (ii) when the control information indicates a negative result.

10. The method according to claim 9, further comprising:
receiving the data from the first data source by the comparison device;
forwarding the data received from the first data source, to the monitoring device by the comparison device before the comparison device has completed the comparison;
performing the comparison by the comparison device; and
transmitting the control information, which indicates the result of the comparison, from the comparison device to the monitoring device.

11. The method according to claim 9, further comprising:
signaling a first fault state to the data sink by the monitoring device when the monitoring device has not received the control information, which indicates the result of the comparison, from the comparison device within the fault detection time after forwarding the received data to the data sink; and
signaling a second fault state to the data sink by the monitoring device when the control information indicates the negative result.

12. The method according to claim 9, wherein the comparison is an M-out-of-N comparison.

13. The method according to claim 9, further comprising:
performing the forwarding for the data received from the data sources for each of multiple processing cycles and triggering a reconfiguration for a data source for which a number of processing cycles: (i) for which a respective comparison indicated that the data from the data source are erroneous, or (ii) for which the data from the data source have been received by the comparison device with a delay above a delay threshold value.

14. A data processing arrangement configured to forward data from a plurality of data sources to a data sink, the data processing arrangement configured to:
forward data received from a first data source of the data sources and forwarded from a comparison device to the data sink by a monitoring device before the monitoring device has received control information, the control information indicates a result of a comparison of the data received from the first data source with data received from one or more second data sources of the data sources, from the comparison device; and
signal a fault state to the data sink: (i) when the monitoring device has not received the control information, which indicates the result of the comparison, from the comparison device within a fault detection time after forwarding the received data to the data sink, or (ii) when the control information indicates a negative result.

15. A non-transitory computer-readable medium on which is stored commands for forwarding data from a plurality of data sources to a data sink, the commands, when executed by a computer, causing the computer to perform the following steps:
forwarding data received from a first data source of the data sources and forwarded from a comparison device to the data sink by a monitoring device before the monitoring device has received control information, the control information indicates a result of a comparison of the data received from the first data source with data received from one or more second data sources of the data sources, from the comparison device; and
signaling a fault state to the data sink: (i) when the monitoring device has not received the control information, which indicates the result of the comparison, from the comparison device within a fault detection time after forwarding the received data to the data sink, or (ii) when the control information indicates a negative result.
